(19) United States
(12) Patent Application Publication
(10) Pub. No.: US 2007/0139678 A1
(43) Pub. Date: Jun. 21, 2007

(54) PROFILE CREATING APPARATUS, PROFILE CREATING PROGRAM STORAGE MEDIUM, AND IMAGE OUTPUT APPARATUS

(75) Inventor: Shuhei Horita, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/611,839

(22) Filed: Dec. 15, 2006

(30) Foreign Application Priority Data
Dec. 15, 2005 (JP) 2005-362160

(51) Int. Cl. G06F 15/00

(52) U.S. Cl. 358/1.9; 358/3.23

(57) ABSTRACT

A profile creating apparatus comprises: a curve creating section that creates plural approximation curves in such a manner that plural output colors, which are displayed by a display according to plural image data representative of plural monochromatic images different from one another in color, are generated, and I/O characteristic of the display is approximated according to plural approximation schemes different from one another; an accuracy computing section that computes approximation accuracy for the I/O characteristic on each of the plural approximation curves created by the curve creating section; a selection section that selects an approximation curve wherein the approximation accuracy computed by the accuracy computing section satisfies a predetermined high accuracy condition, from among the plural approximation curves; and a creating section that creates a profile of the display by using the approximation curve selected by the selection section.

### BACKGROUND OF THE INVENTION

1. Field of the Invention

The present invention relates to a profile creating apparatus that creates a profile for a display, a profile creating program storage medium storing a profile creating program, and an image output apparatus for displaying an image using the profile.

2. Description of the Related Art

Hitherto, as a display unit for displaying a color image, a CRT monitor, which displays an image using a cathode ray tube, has come into wide use. The CRT monitor makes a fluorescent screen of the cathode ray tube emit light by standard colors such as red (R), green (G), and blue (B), and expresses the color of the image by a visual mixture of the luminescence colors.

An image of the CRT monitor is displayed in accordance with image data representative of the image. In this case, it is necessary for the image data to define the color of the image by a color space that depends on the CRT monitor of which the axis of coordinate is each standard color like the above-mentioned. However, in the creating source of the image data, it often happens to create image data in which color is defined by a color space different from the color space that depends on the CRT monitor. Thus, when the image represented by the image data transferred from the creating source is displayed on the CRT monitor, there is performed such processing that the transferred image data is converted into image data in which the color is defined by the color space that depends on the CRT monitor, and the converted image data is inputted to the CAT monitor. The conversion of the image data is performed through the color space of non-dependence on devices such as an image data creating apparatus and the CRT monitor. A monitor profile, which defines an association between the color space that depends on the CRT monitor and the color space of non-dependence in the device, is used for the conversion.

By the way, between image data inputted to the CRT monitor and the luminescence brightness on the fluorescent screen, there is an I/O characteristic in which an electric characteristic of the cathode ray tube is reflected in each the above-mentioned standard color, and it approximates in the following curves. That is, the I/O characteristic for each standard color in the CAT monitor is approximated by the formula f(x)=x^{γ} where x denotes the input signal. The approximation curve approximated to the I/O characteristic is used to make the above-mentioned monitor profile.

By the way, the performance of the liquid crystal monitor improves in recent years, and the liquid crystal monitor has come to be used as a display where it replaces the above-mentioned CRT monitor. Because the liquid crystal monitor is fundamentally different from CRT monitor in the mechanism of the image display, the I/O characteristic of the liquid crystal monitor originally is different from the I/O characteristic of CRT monitor. On the other hand, in the liquid crystal monitor of the color there are a lot of common parts with the CRT monitor in the points that colors are expressed by a visual mixture of two or more standard colors as mentioned above. Then, to look like the characteristic of the CRT monitor in the appearance, the I/O characteristic of a lot of liquid crystal monitors is adjusted on software or hardware basis so that know-how concerning the image display, which has been cultivated by the CRT monitor, can be applied also to the liquid crystal monitor.

Then, when the monitor profile of the display is made, the curve of the expression of f(x)=x^{γ} is often used as an approximation curve to the I/O characteristic of the display regardless of the kind of the display.

On the other hand, regarding the liquid crystal monitor there is proposed a method of making a monitor profile by using the approximation curve in which the I/O characteristic is approximated by the polynomial, or by using the I/O characteristic which is obtained by the measurement (cf. for example, Japanese Patent Laid Open Gazette 2005-196156).

However, there is a lot of liquid crystal monitor that is not enough in adjustment, and thus in some liquid crystal monitors there is a case where an actual I/O characteristic of the liquid crystal monitor might not be able to be approximated enough with the curve of the above-mentioned expression of f(x)=x^{γ}. Further, the approximation method of the I/O characteristic in the polynomial involves a lot of parameters to fix the polynomial, and in the approximation method of the I/O characteristic in the polynomial, it is difficult to uniquely determine polynomials for sufficiently approximating the I/O characteristic. On the other hand, the method of the measurement of the I/O characteristic involves a problem that the I/O characteristic is low in accuracy because of rough measurement density. The reflection of the I/O characteristic of the display in the monitor profile becomes insufficient if the I/O characteristic with low accuracy is used, and the display accuracy of the color falls.

### SUMMARY OF THE INVENTION

In view of the foregoing, it is an object of the present invention to provide a profile creating apparatus that creates a profile onto which I/O characteristic for a display is reflected sufficiently, a profile creating program storage medium storing a profile creating program which causes a computer to operate as the profile creating apparatus, and an image output apparatus that displays an image by an appropriate color by the use of such a profile.

To achieve the above-mentioned object, the present invention provides a profile creating apparatus comprising:

a curve creating section that creates two or more approximation curves in such a manner that on a display responsive to an input of image data representative of an image for displaying the image represented by the image data with a color according to I/O characteristic represented by an inherent curve, two or more output colors, which are displayed by the display in accordance with two or more monochromatic image data representative of two or more monochromatic images different from one another in color, are generated, and the I/O characteristic is approximated in accordance with two or more approximation schemes different from one another by using said two or more monochromatic image data and said two or more output colors;

an accuracy computing section that computes approximation accuracy for the I/O characteristic on each of said two or more approximation curves created by the curve creating section;

a selection section that selects an approximation curve wherein the approximation accuracy computed by the accuracy computing section satisfies a predetermined high accuracy condition, from among said two or more approximation curves; and

a creating section that creates a profile defining an association between a first color space depending on the display and a second color space different from the first color space by using the approximation curve selected by the selection section.

In the profile creating apparatus according to the present invention as mentioned above, it is preferable that the selection section selects an approximation curve satisfying a high accuracy condition that the approximation accuracy computed by the accuracy computing section is highest, from among said two or more approximation curves.

According to the profile creating apparatus of the present invention as mentioned above, as the above-mentioned approximation scheme, for instance some kinds of approximation schemes, by which high approximate accuracy can be expected, are used. This feature makes it possible to determine two or more approximation curves approximated more than to some degree as to the I/O characteristic of the display. And, selection of the approximation curve that approximate accuracy is as the highest as the above-mentioned preferable form for instance makes it possible to obtain the approximation curve approximated enough as to the I/O characteristic of the display. As a result, the profile in which the I/O characteristic of the display is reflected enough can be created by using such an approximation curve.

In the profile creating apparatus according to the present invention as mentioned above, it is preferable that the accuracy computing section determines an approximation color of the output color displayed by the display in accordance with the image data by using the approximation curve, and computes a color difference between the approximation color and the output color in form of the approximation accuracy.

According to the profile creating apparatus of the preferred form as mentioned above, the profile that obtains an output color appropriate on the display is exactly determined when a value, in which the impression of man's externals of the color of color difference is reflected, is adopted as approximate accuracy.

In the profile creating apparatus according to the present invention as mentioned above, it is preferable that the curve creating section uses, as said two or more approximation schemes, two or more approximation schemes in which the I/O characteristic is approximated by two or more polynomials which are different from one another in degree.

According to the profile creating apparatus of the preferred form as mentioned above, it is possible to cope with a variety of I/O characteristics excellently by using the polynomial with high degree of freedom in the approximation.

In the profile creating apparatus according to the present invention as mentioned above, it is preferable that the curve creating section uses, as one of said two or more approximation schemes, an approximation scheme in which the I/O characteristic is approximated by a function where an output value is represented by an index multiplication of input value.

According to the profile creating apparatus of the preferred form as mentioned above, for instance, it is possible to approximate easily the I/O characteristic by using the function in the index multiplying the output value of the input value, that is, the function of f(x)=x^{γ}, when the I/O characteristic of the liquid crystal monitor matched enough to the I/O characteristic of the CRT monitor.

In the profile creating apparatus according to the present invention as mentioned above, it is preferable that the curve creating section generates two or more gray colors, which are displayed by the display in accordance with two or more gray color image data representative of two or more gray color images different from one another in density, are generated, and creates said two or more approximation curves by using said two or more gray color image data and said two or more gray colors.

According to the profile creating apparatus of the preferred form as mentioned above, it is possible to obtain the approximation curve exactly approximated the I/O characteristic of the display of the gray color where man's eyes feel the color difference sensitively.

To achieve the above-mentioned object, the present invention provides a profile creating program storage medium storing a profile creating program, which causes a computer to operate as a profile creating apparatus when the profile creating program is executed in the computer, the profile creating apparatus comprising:

a curve creating section that creates two or more approximation curves, upon receipt of an input of image data representative of an image, in such a manner that on a display for displaying the image represented by the image data with a color according to I/O characteristic represented by an inherent curve, two or more output colors, which are displayed by the display in accordance with two or more monochromatic image data representative of two or more monochromatic images different from one another in color, are generated, and the I/O characteristic is approximated in accordance with two or more approximation schemes different from one another by using said two or more monochromatic image data and said two or more output colors;

an accuracy computing section that computes approximation accuracy for the I/O characteristic on each of said two or more approximation curves created by the curve creating section;

a selection section that selects an approximation curve wherein the approximation accuracy computed by the accuracy computing section satisfies a predetermined high accuracy condition, from among said two or more approximation curves; and

a creating section that creates a profile defining an association between a first color space depending on the display and a second color space different from the first color space by using the approximation curve selected by the selection section.

According to the profile creating program storage medium storing a profile creating program of the present invention as mentioned above, it is possible that the computer easily constructs structural elements of the profile creating apparatus of the present invention.

To achieve the above-mentioned object, the present invention provides an image output apparatus comprising:

a display responsive to an input of image data representative of an image for displaying the image represented by the image data with a color according to I/O characteristic represented by an inherent curve;

a curve creating section that creates two or more approximation curves in such a manner that on the display, two or more output colors, which are displayed by the display in accordance with two or more monochromatic image data representative of two or more monochromatic images different from one another in color, are generated, and the I/O characteristic is approximated in accordance with two or more approximation schemes different from one another by using said two or more monochromatic image data and said two or more output colors;

an accuracy computing section that computes approximation accuracy for the I/O characteristic on each of said two or more approximation curves created by the curve creating section;

a selection section that selects an approximation curve wherein the approximation accuracy computed by the accuracy computing section satisfies a predetermined high accuracy condition, from among said two or more approximation curves; and

a creating section that creates a profile defining an association between a first color space depending on the display and a second color space different from the first color space by using the approximation curve selected by the selection section.

According to the image output apparatus of the present invention, it is possible to display an image with a suitable color by using a profile wherein the I/O characteristic of the display is reflected sufficiently.

With respect to the image output apparatus of the present invention and the profile creating program storage medium of the present invention, only the basic aspects are disclosed here. It is noted that the image output apparatus and the profile creating program storage medium of the present invention include not only the basic aspects, but also various aspects corresponding to the above-mentioned aspects of the profile creating apparatus.

With respect to the structural elements such as the curve creating section constructed on a computer by the profile creating program related to the present invention, it is acceptable that function of one structural element is implemented by one program part, function of one structural element is implemented by a plurality of program parts, or alternatively functions of a plurality structural elements are implemented by one program part. Further, it is acceptable that those structural elements are executed by oneself or by instruction to another program or program parts incorporated into a computer.

### BRIEF DESCRIPTION OF THE DRAWINGS

FIG. 1 is a view useful for understanding an embodiment of the present invention.

FIG. 2 is a hardware structural view of the computer shown in FIG. 1.

FIG. 3 is a view useful for understanding a print proof reading program.

FIG. 4 is a functional block diagram of a print proof reading system.

FIG. 5 is an illustration useful for understanding a structure of an ICC profile.

FIG. 6 is a conceptual view showing an approximation curve of the expression of f(x)=x^{γ}.

FIG. 7 is a conceptual view showing an approximation curve such as a quadratic curve and an octet curve.

FIG. 8 is a conceptual view showing an approximation curve of a septet curve and the expression of f(x)=x^{γ}.

FIG. 9 is an enlarged detail at the low luminance side in FIG. 8.

FIG. 10 is a conceptual view showing an approximation curve of an octet curve and the expression of f(x)=x^{γ}.

### DETAILED DESCRIPTION OF PREFERRED EMBODIMENTS

Embodiments of the present invention will be described with reference to the accompanying drawings.

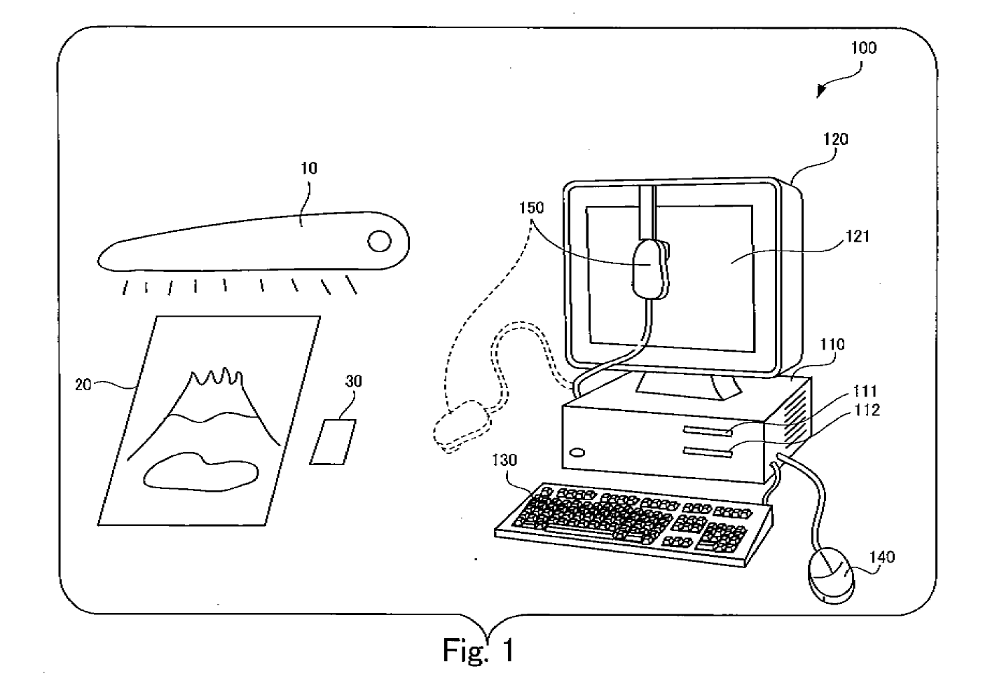

FIG. 1 is a view useful for understanding an embodiment of the present invention.

FIG. 1 shows a print proofreading system that reproduces a color when an image in printed matter 20 is observed under a standard light source 10 from image data representative of the image of the printed matter 20 and displays it on a liquid crystal monitor 120. According to the present embodiment, the print proofreading system is implemented by a computer 100. A main frame unit 110 of the computer 100 incorporates therein a profile creating function.

The computer 100, which constitutes the print proofreading system, comprises the main frame unit 110 that incorporates therein CPU, a RAM memory, a hard disk, and the like, a liquid crystal monitor 120 for displaying images on a display screen 121 in accordance with an input of RGB data from the main frame unit 110, a keyboard 130 for inputting various sorts of information such as a user's instruction and character information to the main frame unit 110 in accordance with a key operation, and a mouse 140 for inputting an instruction according to, for example, an icon and the like, through designation of an optional position on the display screen 121, the icon and the like being displayed on the position on the display screen, The computer 100 further comprises a colorimeter 150 that outputs the XYZ value and the xy value as measurements through measuring the color. The calorimeter 150 is used for colorimetry of the display color on the display screen 121 when it is fixed to the liquid crystal monitor 120, or for colorimetry of the white of a standard white plate 30 is described later when it is removed from the liquid crystal monitor 120.

The main frame unit 110 has, on an external appearance, an FD loading slot 111 wherein a flexible disk (FD) is loaded, and a CD loading slot 112 wherein CD-ROM and CD-R (Hereafter, they are called CD) are loaded. In the main frame unit 110, the FD drive and the CD drive, which drive the loaded FD and CD, respectively, are installed.

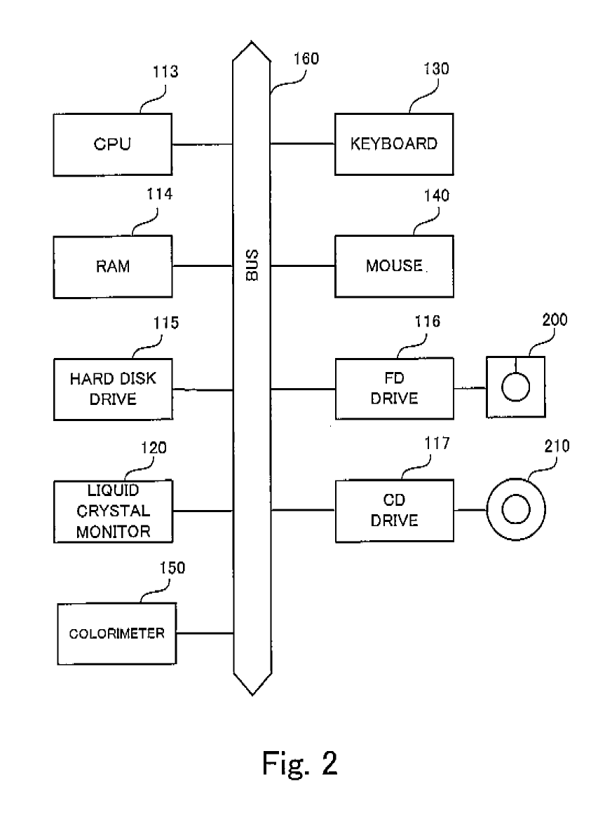

FIG. 2 is a hardware structural view of the computer shown in FIG. 1.

The computer 100 comprises, as shown in FIG. 2, a CPU (Central Processing Unit) 113, a RAM 114, a HDD (hard disk drive) 115, FD drive 116, and CD drive 117. Those various types of elements are connected via a bus 160 to one another. FIG. 2 shows the liquid crystal monitor 120, the keyboard 130, the mouse 140, and the colorimeter 150, which are also shown in FIG. 1, and are connected to the bus 160.

The FD drive 116 and the CD drive 117 are to access FD 200 and CD 210, respectively, as explained with reference to FIG. 1.

In the event that the CD 210 stores a profile creating program which causes the computer 100 to operates as the profile creating apparatus, the CD 210 is loaded from the CD loading slot 112 shown in FIG. 1 into the main frame unit 110, so that the profile creating program is read from the CD 210 by the CD drive 117 and is installed via the bus 160 in the HDD 115 of the computer 100. In the actual execution, the profile creating program in the HDD 115 is loaded on the RAM 114 and then executed by the CPU 113.

It returns to FIG. 1 and it keeps explaining. The liquid crystal monitor 120 is adjusted in such a manner that the I/O characteristic of the appearance of the RGB 3 colors becomes a peculiar I/O characteristic to the CRT monitor represented by the expression named f(x)=x^{γ}. The liquid crystal monitor 120 has a handler with which a user may control γ value in the approximation curve representative of the I/O characteristic of the appearance of the RGR 3, and the luminance of the display color. For example, when the user operates the handler to control the γ value, the I/O characteristic of the appearance of the liquid crystal monitor 120 is adjusted to the characteristic according to the controlled γ value. In this case, one γ value is used on a common basis for the I/O characteristic of the appearance of each of the RGB 3 colors.

The user performs the calibration, which will be explained hereinafter, by operating the handler of the liquid crystal monitor 120, preceding that the computer 100 may work as a print proofreading system.

The user first of all puts the standard white plate 30, which causes the incident light to scatter almost in no absorption, under the standard light source 10, so that the colorimeter 150 measures the color of the standard white plate 30 under the standard light source 10 to obtain the xy value. Next, white is displayed in the liquid crystal monitor 120, and the user measures the white in the monitor through colorimetry with the calorimeter 150 to obtain xy value. Then, the handler is operated to control luminance and γ value in such a manner that the xy value obtained from the white of the liquid crystal monitor 120 is coincident with the xy value obtained from the standard white plate 30. Thus, it is possible to implement the calibration on a hardware basis.

According to the present embodiment, it is shown by way of example that the calibration is implemented by operation of the user. However, the present invention is not restricted to the present embodiment. It is acceptable, for example, that the calibration is incorporated into the main frame unit 110 of the computer 100, and the calibration is implemented by the calibration function on a software basis.

Hereinafter, there will be explained the structure and the operation of the print proofreading system by assumption that such a calibration ends.

First of all, there will be explained a print proofreading which causes the computer 100 to operate as a print proofreading system.

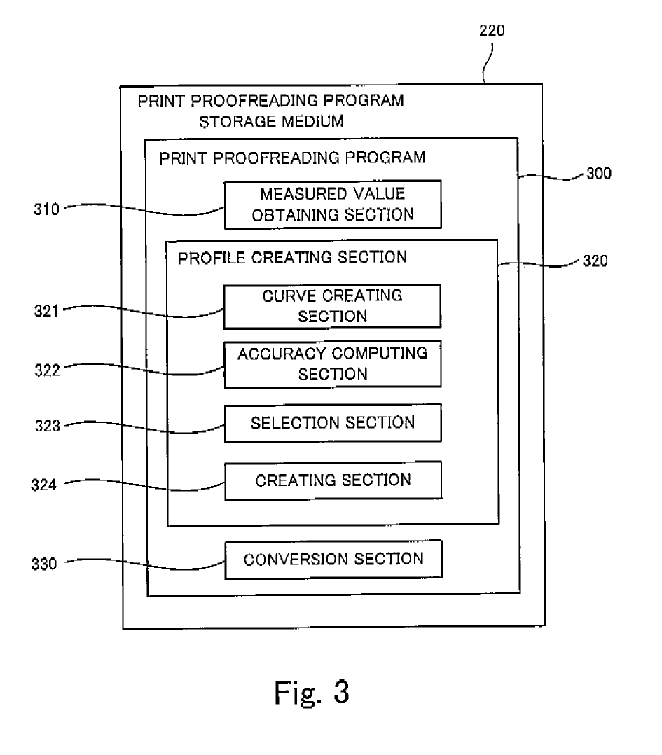

FIG. 3 is a view useful for understanding a print proofreading program.

A print proofreading program 300 shown in FIG. 3 is a program which causes a computer to operate as a print proofreading system. It is noted that any one is acceptable, as a print proofreading program storage medium 220 that stores the print proofreading program 300, which is able to store the program, for example, FD, CD, DVD, a magnetic dick of a hard disk unit, and a semiconductor memory.

The print proofreading program 300 comprises a measured value obtaining section 310, a profile creating section 320, and a conversion section 330. The profile creating section 320 comprises a curve creating section 321, an accuracy computing section 322, a selection section 323, and a creating section 324. The profile creating section 320 corresponds to an example of the profile creating program of the present invention.

Details of those individual structural elements will be described later.

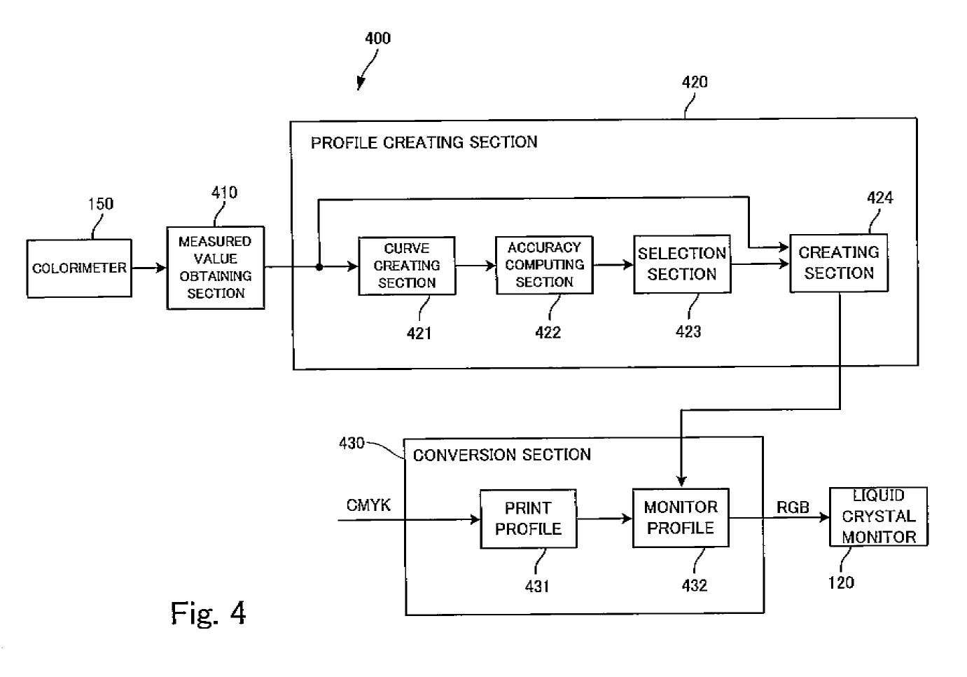

FIG. 4 is a functional block diagram of a print proofreading system.

A print proofreading system 400 is a system which is implemented when the print proofreading program 300 shown in FIG. 3 is incorporated into the computer 100 shown in FIG. 1. The print proofreading system 400 comprises a measured value obtaining section 410, a profile creating section 420, and a conversion section 430. The measured value obtaining section 410, the profile creating section 420, and the conversion section 430 are substantially constructed on the computer 100 by the measured value obtaining section 310, the profile creating section 320, and the conversion section 330, respectively, which constitute the print proofreading program 300. The print proofreading system 400 further comprises the liquid crystal monitor 120 which is shown in FIG. 1 and FIG. 2 too. The print proofreading system 400 corresponds to an embodiment of the image output apparatus of the present invention. The profile creating section 420 shown in FIG. 4 corresponds to an embodiment of the profile creating apparatus of the present invention. The conversion section 430 and the liquid crystal monitor 120 correspond to the embodiments of the conversion section and the display referred to in the present invention, respectively.

The profile creating section 420, which constitutes the print proofreading system 400, comprises a curve creating section 421, an accuracy computing section 422, a selection section 423, and a creating section 424. Those elements are substantially constructed on the computer 100 by the curve creating section 321, the accuracy computing section 322, the selection section 323, and the creating section 324, respectively, which constitute the profile creating section 320. The curve creating section 421, the accuracy computing section 422, the selection section 423, and the creating section 424, which are shown in FIG. 4, correspond to examples of the curve creating section, the accuracy computing section, the selection section, and the creating section referred to in the present invention, respectively.

Hereinafter, first, there will be explained the function of each element that constitutes the print proofreading system 400 summarizing it, and there will be explained details of the function of each element afterwards.

The measured value obtaining section 410 of the print proofreading system 400 obtains the measured value (here, XYZ values) outputted from the calorimeter 150 shown in FIG. 1 and FIG. 2.

The profile creating section 420 creates a monitor profile 432 having an ICC profile structure, which represents of an association between a color space depending on the liquid crystal monitor 120 and a color space of non-dependence on a device, in accordance with the measured value obtained by the measured value obtaining section 410. The color space depending on the liquid crystal monitor 120 corresponds to an example of the first color space referred to in the present invention. The color space of non-dependence on a device corresponds to an example of the second color space referred to in the present invention. The monitor profile 432 corresponds to an example of the profile referred to in the present invention.

The conversion section 430 creates a proof image for proofreading that reproduces a printed matter in accordance with a print profile 431 representative of an association between CMYK data that represents the printed matter to reproduce an image on the liquid crystal monitor 120 and a print color and the monitor profile 432 created by the profile creating section 420, and displays the thus created proof image on the liquid crystal monitor 120.

Now there will be described a structure of the ICC profile.

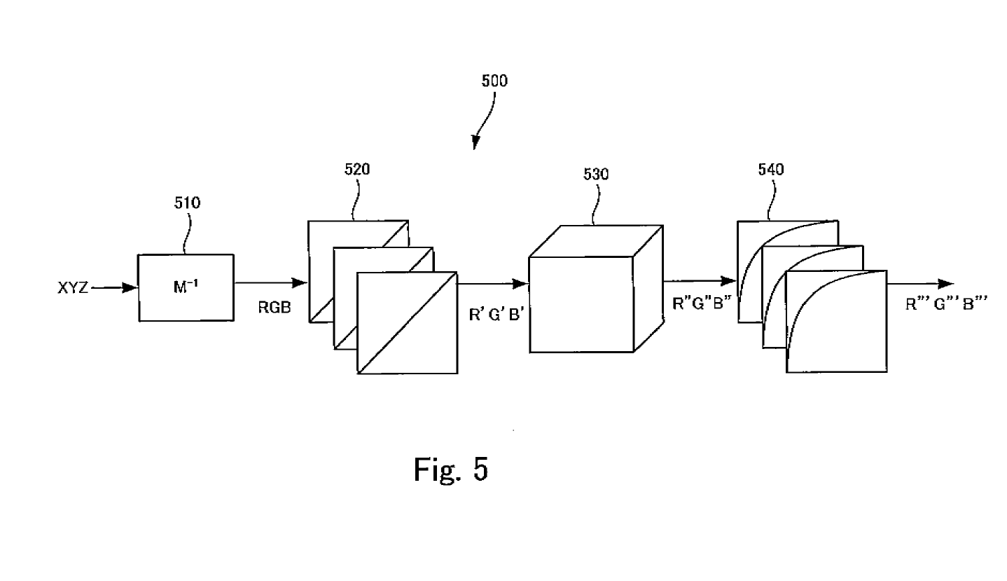

FIG. 5 is an illustration useful for understanding a structure of the ICC profile.

In the ICC profile regulations, some profile structures can be arbitrarily adopted. According to the present invention, however, there is adopted an ICC profile 500 having a structure shown in FIG. 5. The ICC profile 500 comprises: a 3×3 matrix 510 that represents a transformation matrix for converting XYZ values under a standard light source into RGB data; a primary dimensional input side LUT 520 that represents a conversion relation for converting R value, G value and B value, that constitute RGB data, into R′ value, G′ value and B′ value mutually independently; a three-dimensional LUT 530 in which a conversion relation for converting R′G′B′ data consisting of R′ value, G′ value and B′ value into R″G″B″ data consisting of R″ value, G″ value, and B″ value is represented by an association table for a large number of R″G″B″ data associated with a large number of R′G′B′ data; and a primary dimensional output side LUT 540 that represents a conversion relation for converting R″ value, G″ value, and B″ value, that constitute R″G″B″ data, into R′″ value, G′″ value, and B′″ value mutually independently.

Those elements, which constitute the ICC profile 500, are created by the creating section 424 shown in FIG. 4.

The data of the ICC profile 500 that has the structure shown in FIG. 5 is to be stored in B2A tag in the rule of the ICC profile. The B2A tag stores therein each data that represent the 3×3 matrix 510, the primary dimensional input side LUT 520, the three-dimensional LUT 530, and the primary dimensional output side LUT 540.

Next, there will be explained individual structural elements of the print proofreading system 400 shown in FIG. 4.

The measured value obtaining section 410 causes the liquid crystal monitor 120 to sequentially display 112 kinds of patches by means of inputting RGB data which will be described hereinafter, and obtains measured values obtained through the measurement of colors of the individual patches displayed on the liquid crystal monitor 120.

According to the present embodiment, the measured value obtaining section 410 inputs the following RGB data to the liquid crystal monitor 120.

The liquid crystal monitor 120 receives; RGB data of (R,G,B)=(255,255,255), which represents a white patch; 15 kinds of RGB data obtained when R value is varied from (R,G,B)=(17,0,0) to (255,0,0) by 17 steps, which represent 15 tones of R color of patches; 15 kinds of RGB data obtained when G value is varied from (R,G,B)=(0,17,0) to (0,255,0) by 17 steps, which represent 15 tones of G color of patches; 15 kinds of RGB data obtained when 8 value is varied from (R,G,B)=(0,17,0) to (0,255,0) by 17 steps, which represent 15 tones of B color of patches; and 15 kinds of RGB data obtained when R value, G value and E value are varied from (R,G,B)=(0,0,0) to (238,238,238) by 17 steps, which represent 15 tones of gray color of patches. The liquid crystal monitor 120 further receives 51 kinds of RGB data, which represent 51 colors of patches wherein 13 kinds of RGB data overlapping with the above-identified RGB data are removed from 64 kinds of RGB data that is constructed with a combination of 4 kinds of R value, 4 kinds of G value, and 4 kinds of B value, each having values of 0, 85, 170, 255.

While the measured value obtaining section 410 causes the liquid crystal monitor 120 to sequentially display patches represented by 112 kinds of RGS data explained above, the display of the patches is performed in a state that the calorimeter 150 is mounted on the liquid crystal monitor 120 as shown in FIG. 1. The patch is measured with the colorimeter 150 every time each patch is displayed, and the XYZ values of each patch obtained for the measurement are obtained in the measured value obtaining section 410.

In profile creating section 420, first of all, the curve creating section 421 determines about each RGB 3 color two or more approximated approximation curves for the I/O characteristic of the liquid crystal monitor 120 using the XYZ values obtained about individual patches in white and 15 tones of gray color, of the XYZ values obtained in the measured value obtaining section 410. The accuracy computing section 422 computes, about each RGB 3 color, the individual approximation accuracy of two or more approximated approximation curves. The selection section 423 selects, about each RGB 3 color, the one with the highest approximate accuracy from among two or more approximation curves and passes the selected one to the creating section 424. Details of the explanation for the curve creating section 421, the accuracy computing section 422, and the selection section 423 will be described later. Hereinafter, there will be described the creating section 424.

The creating section 424 creates the 3×3 matrix 510, that is, a matrix for converting XYZ values to RGB values using XYZ values which are obtained on individual patches for white, the highest tone of R color, the highest tone of G color, and the highest tone of B color, of the XYZ values obtained in the measured value obtaining section 410. The creating section 424 receives from a user via an operation screen (not illustrated) a tone curve representative of a desired tone, and a parameter regarding a color regulation in which there is provided on the liquid crystal monitor 120 such a regulation that individual colors of two or more color phases become desired colors. The creating section 424 creates the primary dimensional input side LUT 520 shown in FIG. 5 in accordance with the entered tone curve, which causes the tone curve to reflect on the monitor profile, and creates the three-dimensional LUT 530 shown in FIG. 5 in accordance with the entered parameter regarding the color regulation, which causes the color regulation to reflect on the monitor profile. With respect to the method of creating the 3×3 matrix 510, the primary dimensional input side LUT 520, and the three-dimensional LUT 530, it is well known, and no subject of the present invention. Thus, there will be omitted the explanation more than this.

The creating section 424 determines the primary dimensional output side LUT 540 shown in FIG. 5 to convert R″G″B″ data, which is obtained through the conversion C processing by the primary dimensional input side LUT 520 and the three-dimensional LUT 530, into R′″G′″B′″ data which is necessary for display a color represented by R″G″B″ data on the liquid crystal monitor 120. According to the present embodiment, the creating section 424 determines the primary dimensional output side LUT 540 by means of computation of a reverse-function of each approximation curve regarding the RGB 3 color passed from the selection section 423.

The creating section 424 completes the monitor profile 432 by storing in the B2A tag respective data representative of the 3×3 matrix 510, the primary dimensional input side LUT 520, the three-dimensional LUT 530, and the primary dimensional output aide LUT 540.

Next, there will be made in detail an explanation for the curve creating section 421, the accuracy computing section 422, the selection section 423.

The curve creating section 421 determines, as mentioned above, two or more approximated approximation curves for the I/O characteristic of the liquid crystal monitor 120 using the XYZ values obtained about individual patches in white and 15 tones of gray color, of the XYZ values obtained in the measured value obtaining section 410.

Of the XYZ values, the X value corresponds to R color component, the Y value corresponds to G color component, and the Z value corresponds to B color component. Thus, the curve creating section 421 determines an association between the R value of RGB data to be entered to the liquid crystal monitor 120 and the R color component in the output color of the liquid crystal monitor 120, that is, the approximated approximation curve for the I/O characteristic on the R color in form of an association between the R value and the X value. Likely, the curve creating section 421 determines the approximation curve on the B color in form of an association between the G value and the Y value, and determines the approximation curve on the B color in form of an association between the B value and the Z value.

When those approximation curves are determined, the value standardized by “255” that is the maximum value is used about R value, G value, and B value. Moreover, the value standardized by the XYZ value obtained by measuring a white patch is used about the XYZ value obtained by measuring the gray color patch

According to the present embodiment, the curve creating section 421 determines 7 sorts of approximation curves from quadratic curve to octet curve, and the approximation curve of the equation f(x)=x^{γ}.

First, there will be explained the case of determination of the approximation curve of the equation f(x)=x^{γ}.

The curve creating section 421 determines the approximation curve of the equation f(x)=x^{γ} using X value, Y value, and Z value which are obtained on respective patch of 3 tones of gray color such as R=G=B=“102”, “153”, and “204” and white.

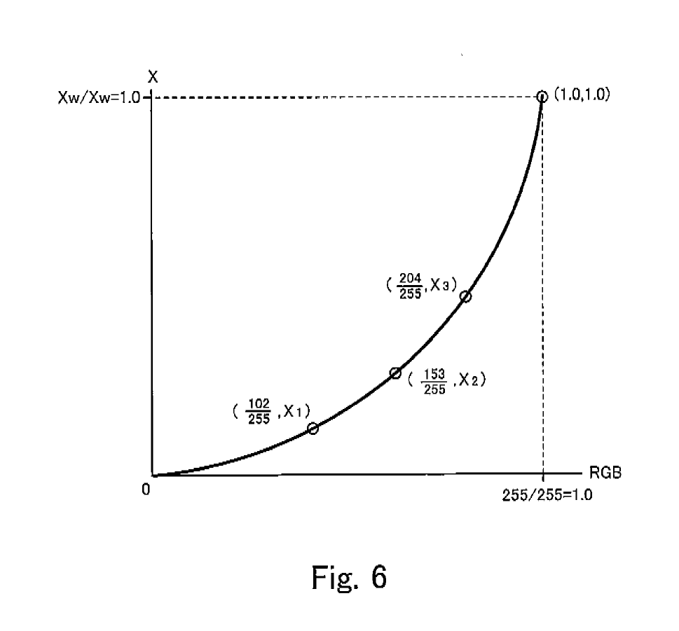

FIG. 6 is a conceptual view showing an approximation curve of the expression of f(x)=x^{γ}.

A horizontal axis of FIG. 6 denotes the standard value of RGB data (R=G=B) of the gray color patch, and a is vertical axis of FIG. 6 denotes the standardized X value. The curve of FIG. 6 denotes the approximation curve. The approximation curve is determined on each of RGB 3 colors. FIG. 6 shows the approximation curve for R color.

As mentioned above, the approximation curve shown in FIG. 6 adopts the equation f(x)=x^{γ}. Thus, the approximation curve is defined by the Y value in the equation f(x)=x^{γ}. Moreover, X value becomes “0” in the black point of R=G=B=0, and it becomes X value Xw (standard value=1.0) of white in a white point of R=G=B=255 (standard value=1.0). These black point and white point correspond to both ends of the approximation curve. Therefore, the γ value in the above-mentioned expression can be calculated from the standardized X values X1, X2, and X3 in 3 tones of gray color patch. Here, because one γ value is used together in the liquid crystal monitor 120 as mentioned above when the I/O characteristic of the appearance of each RGB 3 color is adjusted, according to the present embodiment, the y value, which defines the approximation curve, can be obtained in such a manner that three γ values are computed from 3 standardized X values X1, X2, and X3, and mean value is computed.

The γ value, which defines the approximation curve for R color, is computed from the standardized X values as mentioned above. Likely, γ values, which define the approximation curves for G color and B color, are computed from the standardized Y and Z values, respectively.

Next, there will be explained a case where seven kinds of approximation curves from the quadratic curve to the octet curve are obtained.

The curve creating section 421 determines the seven kinds of approximation curves using X value, Y value, and Z value which are obtained on the respective patches of 15 tones of gray color such as R=G=B=“17”, “34”, . . . “238” and, white. Also here, the value standardized by “255” is used as for RGB data, and the value standardized by a white measurement XYZ value is used as for measurement XYZ value.

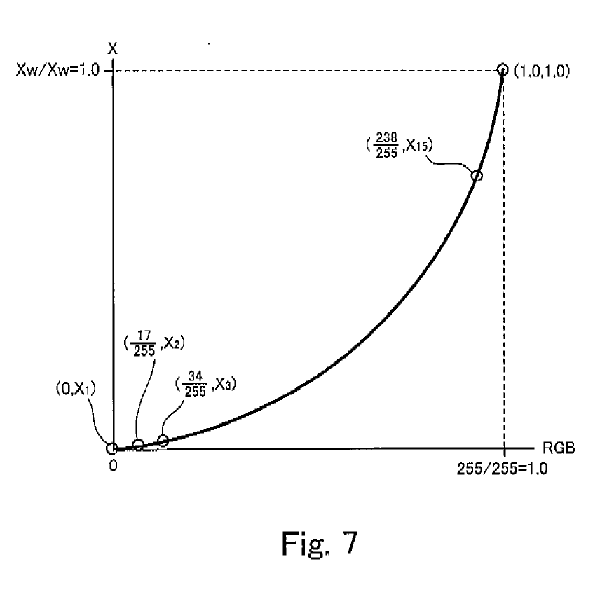

FIG. 7 is a conceptual view showing an approximation curve such as a quadratic curve and an octet curve.

In a similar fashion to that of FIG. 6, a horizontal axis of FIG. 7 denotes the standard value of RGB data (R=G=B) of the gray color patch, and a vertical axis of FIG. 7 denotes the standardized X value. The curve of FIG. 7 denotes the approximation curve. FIG. 7 also shows the approximation curve for R color. As mentioned above, according to the present embodiment, seven kinds of approximation curves from the quadratic curve to the octet curve are obtained. However, in FIG. 7, one of these approximation curves is typically shown.

Here, when the degree of the approximation curve is assumed to be n for instance, the approximation curve is expressed by the following polynomial.
f(x)=Cₙ·xⁿ+Cₙ₋₁·x⁽ⁿ⁻¹⁾+ . . . +C₁·x¹+C₀

First of all, the curve creating section 421 shown in FIG. 4 computes the coefficient in the polynomial. For few instance, three coefficients of C₂, C₁, and C₀ are computed about the polynomial of the quadratic curve, and the coefficient of each polynomial to the octet curve is computed in the same way.

According to the present embodiment, the above-mentioned coefficients are computed by the least square method that uses X values X₁, X₂, X₃, . . . X₁₅, 1.0 in which measurements on patches of 15 tones of gray color and white are standardized.

The coefficient of the polynomial to R color is computed from such a standardized X value, and the coefficients of the polynomials to G color and B color are computed from Y value and the Z value standardized respectively similarly.

Two or more approximation curves, which are determined by the curve creating section 421, are transferred to the accuracy computing section 422.

The accuracy computing section 422 computes the approximation accuracy, of each approximation curve as follows.

First of all, the accuracy computing section 422 computes the XYZ values, which represent the color (prediction color) of the patch that will be output onto the liquid crystal monitor 120, by substituting RGB data that represent the patch for the following computing expression. According to the present embodiment, the computation of the XYZ values is executed about each 112 kinds of RGB data as mentioned above, which represents 112 kinds of above-mentioned patches that contain individual patches of 15 tones of gray color as mentioned above.

$$[ \begin{matrix}{X}_{prof} \\ {Y}_{prof} \\ {Z}_{prof}\end{matrix} ] = {Mchad}^{- 1} \cdot Mpcs \cdot [ \begin{matrix}{f}_{r} ( R ) \\ {f}_{g} ( G ) \\ {f}_{b} ( B )\end{matrix} ] \qquad Expression 1$$

In the expression 1, fr(R) denotes the approximation curve on R color. Likely, fg(G) and fb(B) denote the approximation curves on G color and B color, respectively. M_{pcs} denotes a reverse-matrix of 3×3 matrix 510 shown in FIG. 5, and is one to convert RGB data into the YXZ values under a standard light source. M_{chad}⁻¹ is a matrix for converting the XYZ values under the standard light source into XYZ values representative of an output color to be outputted on the liquid crystal monitor 120. X_{prof}, Y_{prof}, and Z_{prcf} denote XYZ values representative of the prediction color as mentioned above. Regarding the method of creating M_{pcs} and M_{chad}⁻¹, it is well known and no subject of the present invention, and thus the explanation more than this will be omitted.

For the combination of approximation curves fr(R), fg(G), and fb(B) of the RGB 3 colors in the above-mentioned expression, there are used the combination of the RGB 3 colors of the approximation curve of the expression addressed as f(x)=x^{γ} that is explained referring to FIG. 6, and the combination of the RUB 3 colors of the approximation curve of the polynomial that is explained referring to FIG. 7. Moreover, the combination of the approximation curve of the polynomial is mutually composed of the approximation curve as which the degree is the same by the RGB 3 colors, and such seven combinations are used corresponding to seven kinds from the quadratic curve to the octet curve mentioned above to. In a word, according to the present embodiment, the combination of eight pairs mentioned above is used as the combination of approximation curves fr(R), fg(G), and fb(B) of the RGB 3 colors in the above-mentioned expression.

The accuracy computing section 422 executes the following calculations about the combination of these eight pairs.

First of all, the accuracy computing section 422 determines XYZ values X_{prof}, Y_{prof}, and Z_{prof} representative of the above-mentioned prediction color. The XYZ values X_{prof}, Y_{prof}, and Z_{prof} are determined on each of 112 kinds of RGB data as mentioned above. Next, there is determined the color difference between the prediction color represented by the XYZ values X_{prof}, Y_{prof}, and Z_{prof} which are computed from each RGB data and the actual display color represented by the XYZ values obtained in the measured value obtaining section 410 corresponding to the RGB data. In addition, the accuracy computing section 422 computes the mean value (average color difference) of 112 kinds of color differences thus determined. This average color difference corresponds to one example of the approximate accuracy referred to in the present invention.

Eight average color differences determined by such a computation about the combination of eight pairs are transferred to the selection section 423.

The selection section 423 selects the combination with the smallest average color difference among the above-mentioned combination of eight pairs and transfers the selected one to the creating section 424.

The example of the average color difference corresponding to the combination of eight pairs of the approximation curve of the above-mentioned RGB 3 colors and each combination is enumerated as follows.

In Table 1, seven kinds of approximation Curves from the quadratic curve to the octet curve are shown by the coefficient of the polynomial that represents each curve.

TABLE 1

| | | C8 | C7 | C6 | C5 | C4 | C3 | C2 | C1 | C0 |
|---|---|---|---|---|---|---|---|---|---|---|
| QUADRATIC | R | | | | | | | 1.112613 | −0.13002 | 0.010522 |
| | G | | | | | | | 1.106171 | −0.12671 | 0.010768 |
| | B | | | | | | | 1.1106391 | −0.12502 | 0.01009 |
| CUBIC | R | | | | | | 0.161632 | 0.870165 | −0.03613 | 0.003085 |
| | G | | | | | | 0.1893 | 0.822221 | −0.01674 | 0.003112 |
| | B | | | | | | 0.118854 | 0.932411 | −0.05598 | 0.005283 |
| QUARTIC | R | | | | | −0.03519 | 0.232010 | 0.82531 | −0.02697 | 0.00360 |
| | G | | | | | 0.098179 | −0.00706 | 0.945958 | −0.0423 | 0.00402 |
| | B | | | | | −0.09709 | 0.313037 | 0.810045 | −0.0307 | 0.004386 |
| QUINTIC | R | | | | 0.201744 | −0.53955 | 0.67436 | 0.666857 | −0.00678 | 0.00328 |
| | G | | | | 0.460211 | −1.05235 | 1.001998 | 0.582902 | 0.003748 | 0.003163 |
| | B | | | | 0.00532 | −0.31039 | 0.500109 | 0.742737 | −0.02227 | 0.0004225 |
| SEXTIC | R | | | 0.318749 | −0.7485 | 0.530356 | 0.116269 | 0.797417 | −0.01780 | 0.003389 |
| | G | | | 0.690299 | −1.61069 | 1.279328 | −0.20966 | 0.867871 | −0.02044 | 0.003369 |
| | B | | | −0.04023 | 0.20602 | −0.44629 | 0.570741 | 0.726127 | −0.02076 | 0.004211 |
| SEPTET | R | | 2.115471 | −7.0874 | 9.44011 | −6.43081 | 2.503073 | 0.369333 | 0.006881 | 0.003271 |
| | G | | 1.258025 | −3.71279 | 4.448262 | −2.86033 | 1.243999 | 0.625192 | −0.00572 | 0.00332 |
| | B | | 1.925116 | −6.77814 | 9.477830 | −0.78108 | 2.795538 | 0.354790 | 0.00178 | 0.004105 |
| OCTET | R | 6.138888 | −22.4401 | 32.86722 | −24.4703 | 0.565597 | −1.54554 | 0.000836 | −0.01696 | 0.003319 |
| | G | 2.454676 | −8.60080 | 12.32842 | −9.10989 | 3.562002 | −0.40555 | 0.832962 | −0.01520 | 0.003330 |
| | B | 4.970824 | −17.9582 | 25.57419 | −17.9876 | 6.171648 | −0.53132 | 0.7738 | −0.01752 | 0.004144 |

Table 2 shows the approximation curve of the expression f(x)=x^{γ} with γ value.

TABLE 2

| | |
|---|---|
| R | γ = 2.164 |
| G | γ = 2.168 |
| B | γ = 2.152 |

Table 3 shows the average color difference corresponding to each combination of eight pairs shown in Table 1 and Table 2.

TABLE 3

| | AVERAGE COLOR |
|---|---|
| | DIFFERENCE |
| QUADRATIC | 3.471 |
| CUBIC | 1.436 |
| QUARTIC | 1.345 |
| QUINTIC | 1.326 |
| SEXTIC | 1.323 |
| SEPTET | 1.306 |
| OCTET | 1.310 |
| f₍ₓ₎ = x^{γ} | 2.402 |

According to the example shown in Table 1, Table 2 and Table 3, the selection section 423 selects the combination of the septet curve which is the smallest in the average color difference.

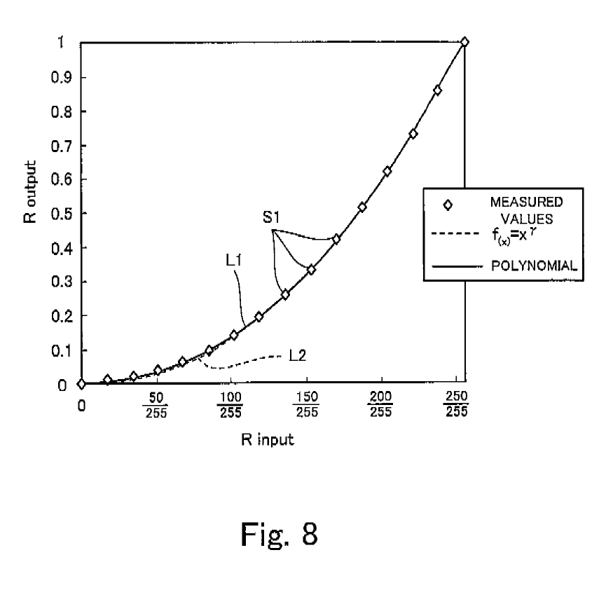

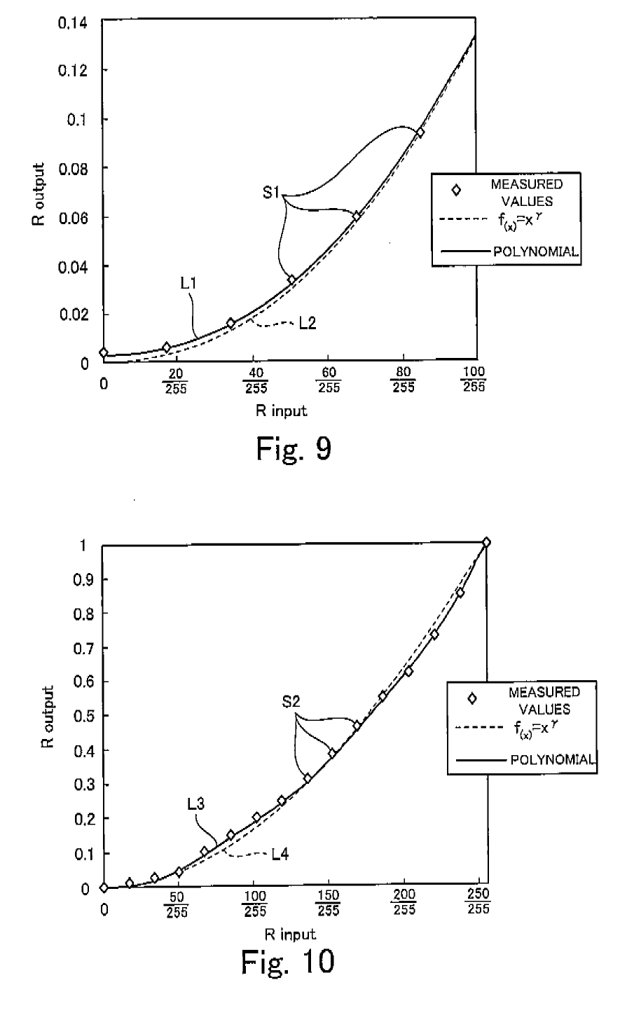

FIG. 8 is a conceptual view showing an approximation curve of a septet curve and the expression of f(x)=x^{γ}. FIG. 9 is an enlarged detail at the low luminance side in FIG. 8.

While the approximation curve of the expression of f(x)=x^{γ} is the one that had been used to show LCD monitor's I/O characteristic so far, FIG. 8 and FIG. 9 show a state that LCD monitor's I/O characteristic is approximated more excellently than the approximation curve of the expression of f(x)=x^{Y} with the septet curve. $ FIG. 8 and FIG. 9 show the septet curve L1 (solid line), the approximation curve L2 (dotted line) of the expression of f(x)=x^{γ}, and the measurement value S1 (white pulling out point) of the I/O characteristic of the liquid crystal monitor 120. From FIG. 8 it is understood that the septet curve L1 especially shows an approximation that is more excellent than the approximation curve L2 of the expression of f(x)=x^{γ} on the low brightness side. According to the example of FIG. 8 and FIG. 9, in the actual I/O characteristic of the liquid crystal monitor 120, the output doesn't become 0 even if the input becomes 0. This causes an error between the approximation curve L2 of the expression of f(x)=x^{γ} and the actual I/O characteristic. This is because the liquid crystal monitor has a structure that changing of the permeability of light that the backlight originates causes changing of the luminescence brightness in the display screen, and the output doesn't become 0 by the leakage light from this backlight even if the input becomes 0.

Next, another example of the approximation curve and the average color difference is enumerated.

Table 4 shows an example different from the example of Table 1 of seven kinds of approximation curves.

TABLE 4

| | | C8 | C7 | C6 | C5 | C4 | C3 | C2 | C1 | C0 |
|---|---|---|---|---|---|---|---|---|---|---|
| QUADRATIC | R | | | | | | | 0.843459 | 0.135196 | −0.0036 |
| | G | | | | | | | 0.82024 | 0.152877 | −0.00527 |
| | B | | | | | | | 0.558573 | 0.511482 | −0.03745 |
| CUBIC | R | | | | | | 0.183002 | 0.558056 | 0.2415 | −0.011 |
| | G | | | | | | 0.14102 | 0.617711 | 0.234793 | −0.01098 |
| | B | | | | | | −0.85393 | 1.839462 | 0.015446 | −0.00291 |
| QUARTIC | R | | | | | 1.562108 | −2.64122 | 2.537700 | −0.16514 | 0.00344 |
| | G | | | | | 1.545470 | −2.94994 | 2.565508 | −0.16752 | 0.003312 |
| | B | | | | | 0.562555 | −1.97904 | 2.546450 | −0.131 | 0.002291 |
| QUINTIC | R | | | | 1.028567 | −1.00931 | −0.68599 | 1.726263 | −0.06222 | 0.001504 |
| | G | | | | 0.979592 | −0.9035 | −0.80290 | 1.792716 | −0.0695 | 0.001467 |
| | B | | | | −1.54494 | 4.424802 | −5.38848 | 3.767244 | −0.28559 | 0.005201 |
| SEXTIC | R | | | 8.488642 | −18.4374 | 20.90788 | −12.0772 | 4.404923 | −0.2896 | 0.003725 |
| | G | | | 6.604589 | −18.0342 | 21.40534 | −12.3968 | 4.519221 | −0.30094 | 0.003729 |
| | B | | | 2.432664 | −8.84293 | 12.6419 | −9.63713 | 4.771496 | −0.37083 | 0.006034 |
| SEPTET | R | | 2.374742 | −1.82296 | −7.00003 | 13.09358 | −9.33274 | 3.946824 | −0.2618 | 0.003594 |
| | G | | 4.061214 | −7.80988 | 0.725601 | 8.041512 | −7.7034 | 3.735793 | −0.2534 | 0.003504 |
| | B | | 7.119163 | −22.4844 | 25.44466 | −10.7844 | −1.40974 | 3.398175 | −0.2875 | 0.00584 |
| OCTET | R | −156.551 | 628.5793 | −1020.73 | 857.9972 | −394.84 | 95.44338 | −9.25032 | 0.348073 | 0.002362 |
| | G | −153.726 | 818.9888 | −1008.13 | 850.115 | −392.531 | 95.18213 | −9.22322 | 0.343504 | 0.002295 |
| | B | −205.013 | 827.1709 | −1356.8 | 1158.209 | −544.997 | 135.8007 | −13.8843 | 0.508547 | 0.004027 |

Table 5 shows an example different from the example of Table 2 of the approximation curve of the expression of f(x)=x^{γ}.

TABLE 5

| | |
|---|---|
| R | γ = 1.910 |
| G | γ = 1.887 |
| B | γ = 1.414 |

Table 6 shows the average color difference on the examples of Table 4 and Table 5.

TABLE 6

| | AVERAGE COLOR |
|---|---|
| | DIFFERENCE |
| QUADRATIC | 19.83 |
| CUBIC | 8.36 |
| QUARTIC | 4.56 |
| QUINTIC | 3.98 |
| SEXTIC | 4.12 |
| SEPTET | 4.07 |
| OCTET | 3.88 |
| f₍ₓ₎ = x^{γ} | 6.12 |

According to the examples shown in FIG. 4 to Table 6, the selection section 423 selects the combination of the octet curves.

FIG. 10 is a conceptual view showing an approximation curve of an octet curve and the expression of f(x)=x^{γ}.

As mentioned above, a hardware adjustment to model the I/O characteristic of the appearance on the I/O characteristic of CRT monitor is given in the liquid crystal monitor. The examples shown in Table 4 to Table 6 are examples of obtaining the approximation curve of the liquid crystal monitor with low accuracy of the adjustment of the I/O characteristic of the appearance. Because the CRT monitor has the I/O characteristic represented by the expression of f(x)=x^{γ}, the I/O characteristic of the liquid crystal monitor should be able to be approximated like the example of FIG. 8 for instance to some degree by this expression, too. However, the approximation curve L4 (dotted line) of the expression of f(x)=x^{γ} comes off from the actual I/O characteristic that measurements S2 (white pulling out point) show greatly in the example shown until Table 6 from Table 4 as understood from FIG. 10 because the accuracy of the adjustment is low. On the other hand, according to the present embodiment, the approximation curve that is good in accuracy can be obtained, as shown in FIG. 10, by the polynomial on the liquid crystal monitor with low accuracy of such an adjustment too.

As explained giving examples above, according to the present embodiment, the combination of the approximation curve with good accuracy is obtained in the selection section 423. And, the combination is transferred to the creating section 424. Further, according to the present embodiment, in the delivery of the combination of this approximation curve, the combination of the γ value in which the approximation curve is defined is passed about the combination of the approximation curve of the expression of f(x)=x^{γ}, and the combination of the coefficient in which the approximation curve is defined is passed about the combination of the approximation curve of the polynomial.

The creating section 424 determines the primary dimensional output side LUT 540 in the ICC profile 500 in accordance with the combination passed like this. Here, the primary dimensional output side LUT 540 is determined by computation of a reverse-function of the approximation curve.

First of all, when the creating section 424 of FIG. 4 receives the combination of the γ value, it will be explained.

The reverse-function of the approximation curve of the expression of f(x)=x^{γ} that is defined by the y value is expressed by the expression of f(x)=x^{1/γ}. Then, the creating section 424 determines the primary dimensional output side LUT 540 in accordance with the reverse-function fixed by simply substituting the γ value in which the received combination is done for the expression f(x)=x^{1/γ}.

Next, when the creating section 424 in FIG. 4 receives the combination of the coefficient, it will be explained.

Here, it is difficult to determine a reverse-function of the polynomial in the form of the expression. Then, according to the present embodiment, the approximation curve of the polynomial, which is defined by the coefficient involved in the received combination, is made LUT, and the primary dimensional output side LUT 540, which represents a reverse-function of the approximation curve of the polynomial, is determined in accordance with the LUT.

First of all, there is created LUT of one dimension, which comprises 4096 input values of the equal intervals between from 0 to 1.0 and output values at inequitable intervals corresponding to the input values, in accordance with an approximation curve defined by the coefficient, which LUT represents the approximation curve. NGxt, the input value at inequitable intervals that corresponds to 4096 output values of the equal intervals between from 0 to 1.0 in the above-mentioned approximation curve is determined by the interpolation operation that uses above-mentioned LUT of one dimension. And, the primary dimensional output side LUT 540, which represents a reverse-function of the approximation curve defined by the above-mentioned coefficient, is created by assuming 4096 output values of equal intervals to be an input value, and assuming the input value at inequitable intervals determined by the interpolation operation to be an output value.

The creating section 424 in FIG. 4 creates the monitor profile 423 by using the primary dimensional output side LUT 540 thus determined. Because the monitor profile 423 thus created is reflected with great accuracy in the I/O characteristic of the liquid crystal monitor 120, it is highly accurate. The conversion section 430 in FIG. 4 can display the proof image for the proofreading in color on the liquid crystal monitor 120 with great accuracy by using the monitor profile 423 of the great accuracy.

According to the present embodiment, because the operation required for an operator to obtain the approximation curve approximated enough a peculiar I/O characteristic to the liquid crystal monitor is only an operation of directing it like displaying 112 kinds of patches mentioned above on the liquid crystal monitor 120, the operator's load is very light.

As explained above, according to the present embodiment, it is possible to easily create the profile in which the I/O characteristic of the liquid crystal monitor is reflected enough, and whereby a color can be appropriately displayed on the liquid crystal monitor by using such a profile.

According to the above-mentioned explanation, as one example of the selection section referred to in the present invention, there is raised the selection section 423 for selecting the approximation curve in which the average color difference computed as approximate accuracy was minimized, from among two or more approximation curves. However, the present invention is not restricted to the present embodiment. It is acceptable that the selection section of the present invention may select, from among two or more approximation curves, the approximation curve wherein an average color difference computed as approximate accuracy is in a prescribed high rank such as next mark and third mark. Alternatively it is acceptable that the selection section of the present invention may select one approximation curve arbitrarily from among the approximation curves that the value of the average color difference computed as approximate accuracy falls below a prescribed threshold.

Further, according to the above-mentioned explanation, as one example of the output color referred to in the present invention, there are illustrated, by way of example, 112 colors in the liquid crystal monitor of the display according to 112 kinds of RGB data prepared beforehand. However, it is acceptable that the output color referred to in the present invention is a color etc. decided for instance according to the operator's operation.

Furthermore, according to the above-mentioned explanation, as one example of the accuracy computing section referred to in the present invention, there is shown, by way of example, the accuracy computing section 422 for computing, as the accuracy of an approximation curve, the average of a color difference between a color represented by the computed value according to the is approximation curve and a color represented by the measured value, on all 112 colors. However, it is acceptable that the accuracy computing section referred to in the present invention is for instance one that computes as accuracy the weighted mean determined after the weighting is applied to the color difference of each color, or alternatively it is acceptable that the accuracy computing section referred to in the present invention is ones in which weight of each color is assumed to be weight according to the operation of an operator.

Still further, according to the above-mentioned explanation, as one example of the color data referred to in the present invention, there is illustrated the RGB data. However, it is acceptable that the color data referred to in the present invention is CMY data etc. for instance.

Still furthermore, according to the above-mentioned explanation, there is shown an example in which the output color referred to in the present invention is expressed by XYZ values. However, it is acceptable that the output color referred to in the present invention is expressed by Lab values for instance.

As mentioned above, according to a profile creating apparatus and a profile creating program storage medium storing a profile creating program, of the present invention, it is possible to create a profile onto which I/O characteristic for a display is reflected sufficiently, and according to an image output apparatus of the present invention, it is possible to display an image with a suitable color using the profile.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A profile creating apparatus comprising:
a curve creating section that creates two or more approximation curves in such a manner that on a display responsive to an input of image data representative of an image for displaying the image represented by the image data with a color according to I/O characteristic represented by an inherent curve, output colors, which are displayed by the display in accordance with monochromatic image data representative of two or more monochromatic images different from one another in color, are generated, and the I/O characteristic is approximated in accordance with two or more approximation schemes different from one another by using said monochromatic image data and said output colors;
an accuracy computing section that computes approximation accuracy for the I/O characteristic on each of said two or more approximation curves created by the curve creating section;
a selection section that selects an approximation curve wherein the approximation accuracy computed by the accuracy computing section satisfies a predetermined high accuracy condition, from among said two or more approximation curves; and
a creating section that creates a profile defining an association between a first color space depending on the display and a second color space different from the first color space by using the approximation curve selected by the selection section.

2. A profile creating apparatus according to claim 1, wherein the selection section selects an approximation curve satisfying a high accuracy condition that the approximation accuracy computed by the accuracy computing section is highest, from among said two or more approximation curves.

3. A profile creating apparatus according to claim 1, wherein the accuracy computing section determines an approximation color of the output color displayed by the display in accordance with the image data by using the approximation curve, and computes a color difference between the approximation color and the output color in form of the approximation accuracy.

4. A profile creating apparatus according to claim 1, wherein the curve creating section uses, as said two or more approximation schemes, two or more approximation schemes in which the I/O characteristic is approximated by two or more polynomials which are different from one another in degree.

5. A profile creating apparatus according to claim 1, wherein the curve creating section uses, as one of said two or more approximation schemes, an approximation scheme in which the I/O characteristic is approximated by a function where an output value is represented by an index multiplication of input value.

6. A profile creating apparatus according to claim 1, wherein the curve creating section generates gray colors, which are displayed by the display in accordance with gray color image data representative of gray color images different from one another in density, are generated, and creates said two or more approximation curves by using said gray color image data and said gray colors.

7. A profile creating program storage medium storing a profile creating program, which causes a computer to operate as a profile creating apparatus when the profile creating program is executed in the computer, the profile creating apparatus comprising:
a curve creating section that creates two or more approximation curves, upon receipt of an input of image data representative of an image, in such a manner that on a display for displaying the image represented by the image data with a color according to I/O characteristic represented by an inherent curve, output colors, which are displayed by the display in accordance with monochromatic image data representative of monochromatic images different from one another in color, are generated, and the I/O characteristic is approximated in accordance with two or more approximation schemes different from one another by using said monochromatic image data and said output colors;
an accuracy computing section that computes approximation accuracy for the I/O characteristic on each of said two or more approximation curves created by the curve creating section;
a selection section that selects an approximation curve wherein the approximation accuracy computed by the accuracy computing section satisfies a predetermined high accuracy condition, from among said two or more approximation curves; and
a creating section that creates a profile defining an association between a first color space depending on the display and a second color space different from the first color space by using the approximation curve selected by the selection section.

8. An image output apparatus comprising:
a display responsive to an input of image data representative of an image for displaying the image represented by the image data with a color according to I/O characteristic represented by an inherent curve;
a curve creating section that creates two or more approximation curves in such a manner that on the display, output colors, which are displayed by the display in accordance with monochromatic image data representative of monochromatic images different from one another in color, are generated, and the I/O characteristic is approximated in accordance with two or more approximation schemes different from one another by using said monochromatic image data and said output colors;
an accuracy computing section that computes approximation accuracy for the I/O characteristic on each of said two or more approximation curves created by the curve creating section;
a selection section that selects an approximation curve wherein the approximation accuracy computed by the accuracy computing section satisfies a predetermined high accuracy condition, from among said two or more approximation curves; and
a creating section that creates a profile defining an association between a first color space depending on the display and a second color space different from the first color space by using the approximation curve selected by the selection section.
